(19) United States
(12) Patent Application Publication
(10) Pub. No.: US 2007/0251042 A1
(43) Pub. Date: Nov. 1, 2007

(54) PAINT ROLLER FRAME WITH HOLDING RINGS

(76) Inventor: Song Kim, Rancho Palos Verdes, CA (US)

Correspondence Address: PARK LAW FIRM, 3255 WILSHIRE BLVD, SUITE 1110, LOS ANGELES, CA, 90010, US

(21) Appl. No.: 11/308,762

(22) Filed: Apr. 28, 2006

(51) Int. Cl. B05C 17/02

(52) U.S. Cl. 15/230.11; 492/13; 492/19

(57) ABSTRACT

A paint roller frame with holding ring for a roller cover includes an axle shaft, a cylindrical roller, and a holding ring. The axle shaft has a terminating end and a connecting end. The cylindrical roller is provided around the axle shaft. And the holding ring is provided close to the connecting end of the axle shaft and fixed to the cylindrical roller. The holding ring holds the roller cover against a predetermined magnitude of lateral force, wherein the holding ring releases the roller cover when a lateral force larger than the predetermined magnitude is applied sideways toward the terminating end of the axle shaft. The holding ring includes an inner surface, an outer surface, and two side walls.

### BACKGROUND OF THE INVENTION

The present invention relates to a paint roller frame with holding ring which holds the roller cover.

More particularly, this invention relates to a paint roller frame with a plurality of metal rings that impart a holding force of a predetermined magnitude.

Considering the wide range of use of all kinds of paint, paint rollers are indispensable.

The human eyes usually can see the outer appearance of everything, outlooks only in almost all the cases. The world consists of one to three dimensional geometrical objects; point, surface, and volume. But, a point is too isolated and small to be seen easily, and the inside of a volume is out of reach of the eyes. Therefore, nearly everything we can see is surfaces of one sort or other.

And the paint is for decorating or protecting the surfaces. It is not a wonder that the world has spent so much paint since its ancient discovery.

Paint rollers are preferred to the brushes in painting a large surface.

The usage of the paint rollers has made the desirable improvements clear to the users. Sometimes, the roller cover should be changed according to the color of paint, the size of the area to paint, the condition of the surface to paint, and the like. Still, the paint roller frame has to hold the roller cover tight enough to finish painting.

Accordingly, a need for a paint roller frame with holding ring has been present for a long time considering the wide range of use of the paint. This invention is directed to solve these problems and satisfy the long-felt need.

### SUMMARY OF THE INVENTION

The present invention contrives to solve the disadvantages of the prior art.

An object of the invention is to provide a paint roller frame with holding ring which holds the roller cover.

Another object of the invention is to provide a paint roller frame with a plurality of metal rings that impart a holding force of a predetermined magnitude.

Still another object of the invention is to provide a paint roller frame with a plurality of metal rings that releases the roller cover when a predetermined magnitude of lateral force is applied.

A paint roller frame with holding ring for a roller cover includes an axle shaft, a cylindrical roller, and one or more holding rings.

The axle shaft has a terminating end and a connecting end. The cylindrical roller is provided around the axle shaft. And the holding ring is provided close to the connecting end of the axle shaft and fixed to the cylindrical roller.

The holding ring holds the roller cover against a predetermined magnitude of lateral force, wherein the holding ring releases the roller cover when a lateral force larger than the predetermined magnitude is applied sideways toward the terminating end of the axle shaft.

The holding ring includes an inner surface, an outer surface, and two side walls.

The cylindrical roller includes a plurality of sleeves for rotatably holding the axle shaft, a terminating end cap fixed around the sleeve at the terminating end of the axle shaft, a connecting end cap fixed around the sleeve at the connecting end of the axle shaft, and a center tube fixed around and between the terminating and connecting end caps.

The cylindrical roller further includes a circumferential groove between the center tube and the connecting end cap, and the inner surface of the holding ring is snugged into the circumferential groove to keep the holding ring from moving longitudinally.

The outer surface of the holding ring is adapted to impart the predetermined magnitude of holding force to the roller cover.

The predetermined magnitude of holding force is overcome by a jerking motion of a hand.

The predetermined magnitude of the holding force is controlled by the shape of the contour of the outer surface of the holding ring.

The holding ring is made of metal. The holding ring may further include a wedge-shaped groove along the outer circumference. The holding ring is closed.

Alternatively, the holding ring is open, and the holding ring has a tension toward the center for hugging the cylindrical roller. The holding ring is made of rubber. The holding ring is closed.

The cylindrical roller is rotatably fixed to the axle shaft.

The paint roller frame may further include a handle shaft and a hand grip.

The handle shaft is connected to the connecting end of the axle at a first end, and the hand grip is provided at a second end of the handle shaft.

The handle shaft is bent so that the hand grip is extended substantially perpendicularly to the axle shaft.

The cross-sectional contour of the holding ring is angular or curved.

The outer surface of the holding ring is rough to impart a predetermined of friction to the lateral motion of the roller cover.

Alternatively, the holding ring is made of steel. The holding ring further includes a gap of a predetermined angle. The predetermined angle is approximately forty five (45) degrees.

The cylindrical roller may further include a end cap cover fixed to the terminating end cap in addition to the plurality of sleeves, the terminating end cap, the connecting end cap, and the center tube.

The advantages of the present invention are: (1) the paint roller frame is convenient to use; and (2) the paint roller frame is adapted to hold the roller cover strong enough and to release the roller cover easily enough.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a cross-sectional view a paint roller frame according to the present invention;

FIG. 2 is a plan view of the handle of FIG. 1;

FIG. 3 is a partial cross-sectional view of a connecting end cap;

FIG. 4 is a front plan view of FIG. 3;

FIG. 5 is a partial cross-sectional view of a terminating end cap;

FIG. 6 is a front plan view of FIG. 5;

FIG. 7 is a partial cross-sectional view of a cap cover;

FIG. 8 is a front plan view of FIG. 7;

FIG. 9 is a partial cross-sectional view of a sleeve;

FIG. 10 is a front plan view of FIG. 9;

FIG. 11 is a cross-sectional view of a center tube;

FIG. 12 is a front plan view of FIG. 11;

FIG. 13 is a side plan view of a holding ring with open ends;

FIG. 14 is a detailed cross-sectional view of FIG. 13;

FIG. 15 is a top plan view of FIG. 13; and

FIG. 16 is a top plan view of a holding ring with a full circumference.

### DETAILED DESCRIPTION OF THE INVENTION

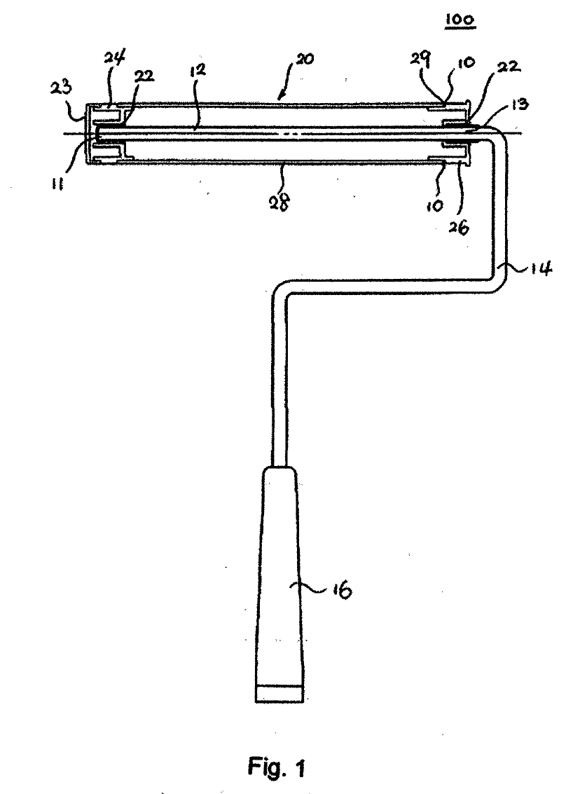

FIG. 1 shows a cross-sectional view of a paint roller frame 100 with holding rings 10 according to the present invention.

The paint roller frame 100 with holding ring 10 for a detachable roller cover (not shown) includes an axle shaft 12, a cylindrical roller 20, and one or more holding rings 10.

The axle shaft 12 has a terminating end 11 and a connecting end 13. The cylindrical roller 20 is provided around the axle shaft 12. And the holding ring 10 is provided close to the connecting end 13 of the axle shaft 12 and fixed to the cylindrical roller 20.

The holding ring 10 holds the roller cover against a predetermined magnitude of lateral force, wherein the holding ring 10 releases the roller cover when a lateral force larger than the predetermined magnitude is applied sideways toward the terminating end 11 of the axle shaft 12.

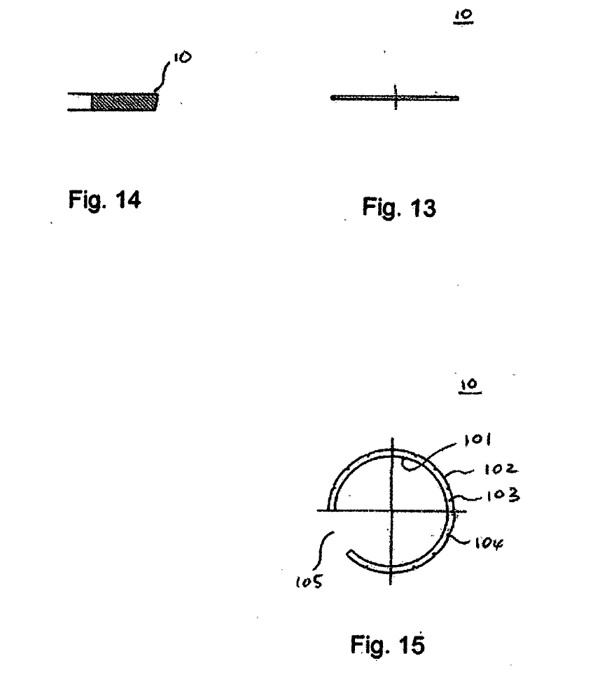

The holding ring 10 includes an inner surface 101, an outer surface 102, and two side walls 103 as shown in FIGS. 13 through 16.

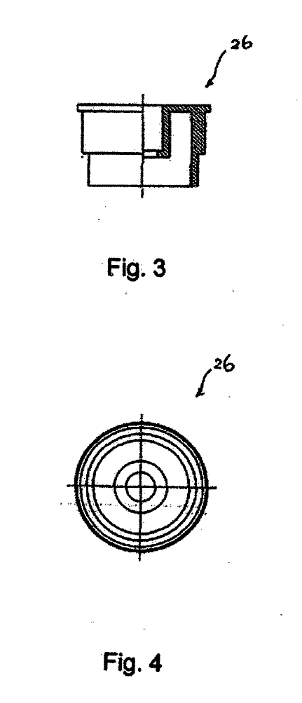

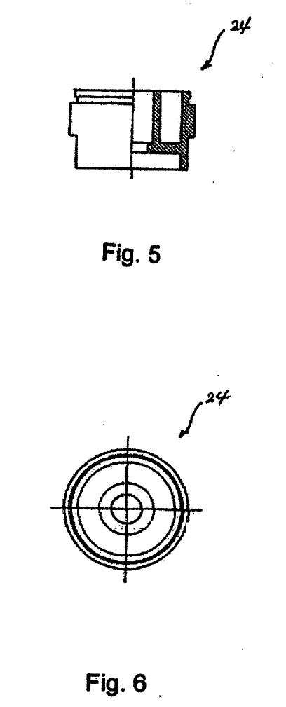

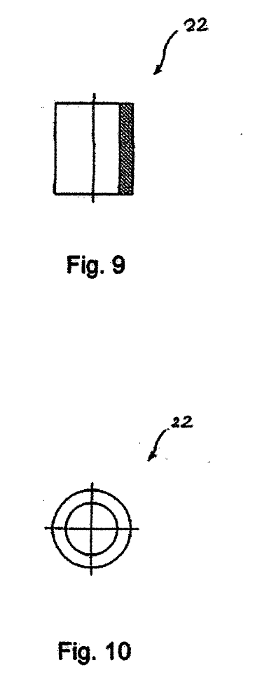

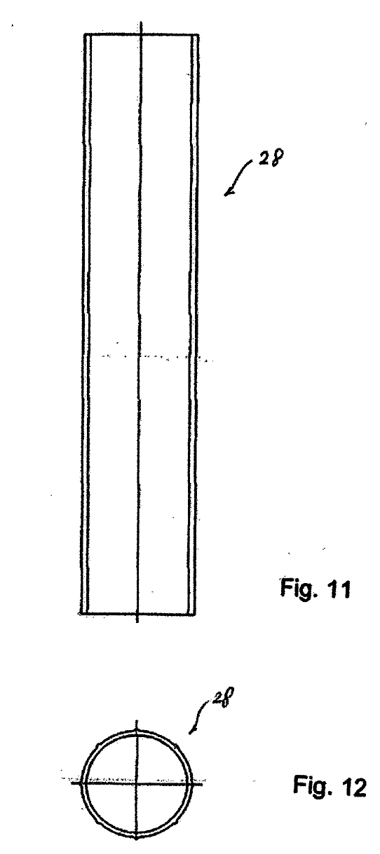

The cylindrical roller 20 includes a plurality of sleeves 22 (refer to FIG. 9 and FIG. 10) for rotatably holding the axle shaft 12, a terminating end cap 24 (refer to FIG. 5 and FIG. 6) fixed around the sleeve 22 at the terminating end 11 of the axle shaft 12, a connecting end cap 26 (refer to FIG. 3 and FIG. 4) fixed around the sleeve 22 at the connecting end 13 of the axle shaft 12, and a center tube 28 (refer to FIG. 11 and FIG. 12) fixed around and between the terminating and connecting end caps 24, 26.

The cylindrical roller 20 further includes a circumferential groove 29 between the center tube 28 and the connecting end cap 26, and the inner surface 101 of the holding ring 10 is snugged into the circumferential groove 29 to keep the holding ring 10 from moving longitudinally.

The outer surface 102 of the holding ring 10 is adapted to impart the predetermined magnitude of holding force to the roller cover.

The predetermined magnitude of holding force is overcome by a jerking motion of a hand. Thereby, the a user of the paint roller frame 100 can release a roller cover easily by jerking the paint roller frame or striking the handle part against a rim of a paint pail.

The predetermined magnitude of the holding force is controlled by the shape of the contour of the outer surface 102 of the holding ring 10.

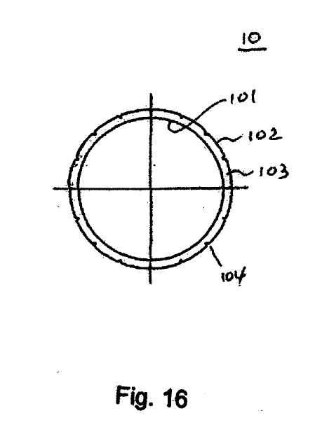

The holding ring 10 is made of metal. The holding ring 10 may further include a wedge-shaped groove 104 along the outer circumference as shown in FIG. 15 and FIG. 16. The holding ring 10 is closed as shown in FIG. 16.

Alternatively, the holding ring 10 is open as shown in FIG. 15, and the holding ring 10 has a tension toward the center for hugging the cylindrical roller 20.

The holding ring 10 is made of rubber, where the holding ring 10 is closed.

The cylindrical roller 20 is rotatably fixed to the axle shaft 12.

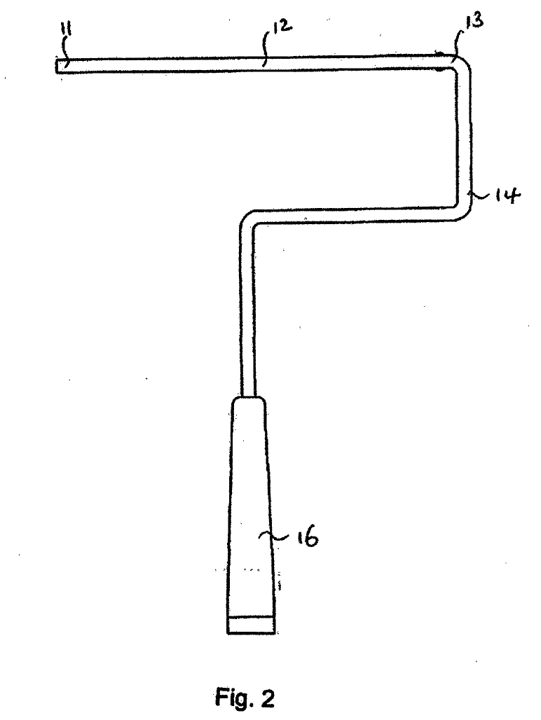

The paint roller frame 100 may further include a handle shaft 14 and a hand grip 16 as shown in FIG. 1 and FIG. 2.

The handle shaft 14 is connected to the connecting end 13 of the axle shaft 12 at a first end, and the hand grip 16 is provided at a second end of the handle shaft 14.

The handle shaft 14 is bent so that the hand grip 16 is extended substantially perpendicularly to the axle shaft 12.

The cross-sectional contour of the holding ring 10 is angular or curved.

The outer surface 102 of the holding ring 10 may be rough to impart a predetermined of friction to the lateral motion of the roller cover.

Alternatively, the holding ring 10 is made of steel. The holding ring 10 may further include a gap 105 of a predetermined angle as shown in FIG. 15. The predetermined angle is approximately forty five (45) degrees.

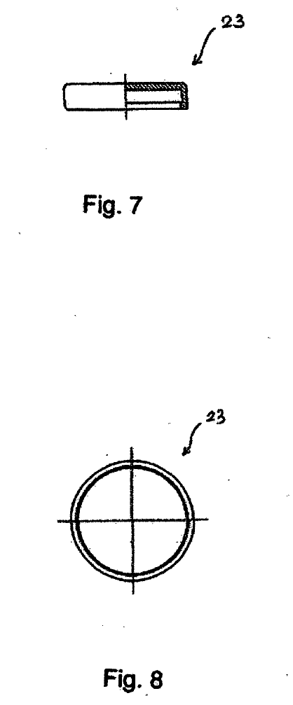

The cylindrical roller 20 may further include an end cap cover 23 (refer to FIG. 7 and FIG. 8) fixed to the terminating end cap 24 in addition to the plurality of sleeves 22, the terminating end cap 24, the connecting end cap 26, and the center tube 28 as shown in FIG. 1, FIG. 7, and FIG. 8.

In FIG. 14, the outer surface 102 and the side walls 103 of the holding ring 10 may meet each other at an angle other than a right angle; preferably 75 to 105 degrees.

The wedge-shaped groove 104 of the holding ring 10 is preferably 50 to 70 degrees as shown in FIG. 15 and FIG. 16.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A paint roller frame with holding ring for a detachable roller cover comprising:
a) an axle shaft having a terminating end and a connecting end;
b) a cylindrical roller provided around the axle shaft; and
c) one or more holding rings, provided close to the connecting end of the axle shaft and fixed to the cylindrical roller,
wherein the holding ring holds the roller cover against a predetermined magnitude of lateral force, wherein the holding ring releases the roller cover when a lateral force larger than the predetermined magnitude is applied sideways toward the terminating end of the axle shaft.

2. The paint roller frame of claim 1, wherein the holding ring comprises an inner surface, an outer surface, and two side walls.

3. The paint roller frame of claim 1, wherein the cylindrical roller comprises:
a) a plurality of sleeves for rotatably holding the axle shaft;
b) a terminating end cap fixed around the sleeve at the terminating end of the axle shaft;
c) a connecting end cap fixed around the sleeve at the connecting end of the axle shaft; and
d) a center tube fixed around and between the terminating and connecting end caps.

4. The paint roller frame of claim 3, wherein the cylindrical roller further comprises a circumferential groove between the center tube and the connecting end cap, wherein the inner surface of the holding ring is snugged into the circumferential groove to keep the holding ring from moving longitudinally.

5. The paint roller frame of claim 2, wherein the outer surface of the holding ring is adapted to impart the predetermined magnitude of holding force to the roller cover.

6. The paint roller frame of claim 5, wherein the holding force is overcome by a jerking motion of a hand.

7. The paint roller frame of claim 5, wherein the predetermined magnitude of the holding force is controlled by the shape of the contour of the outer surface of the holding ring.

8. The paint roller frame of claim 1, wherein the holding ring is made of metal, wherein the holding ring further comprises a wedge-shaped groove along the outer circumference.

9. The paint roller frame of claim 8, wherein the holding ring is closed.

10. The paint roller frame of claim 8, wherein the holding ring is open, wherein the holding ring has a tension toward the center.

11. The paint roller frame of claim 1, wherein the holding ring is made of rubber.

12. The paint roller frame of claim 11, wherein the holding ring is closed.

13. The paint roller frame of claim 1, wherein the cylindrical roller is rotatably fixed to the axle shaft.

14. The paint roller frame of claim 1, further comprising:
a) a handle shaft connected to the connecting end of the axle shaft at a first end; and
b) a hand grip provided at a second end of the handle shaft, wherein the handle shaft is bent so that the hand grip is extended substantially perpendicularly to the axle shaft.

15. The paint roller frame of claim 14, wherein the cross-sectional contour of the holding ring is angular.

16. The paint roller frame of claim 14, wherein the cross-sectional contour of the holding ring is curved.

17. The paint roller frame of claim 14, wherein the outer surface of the holding ring is rough to impart a predetermined of friction to the lateral motion of the roller cover.

18. The paint roller frame of claim 1, wherein the holding ring is made of steel, wherein the holding ring further comprises a gap of a predetermined angle.

19. The paint roller frame of claim 18, wherein the predetermined angle is approximately forty five (45) degrees.

20. The paint roller frame of claim 1, wherein the cylindrical roller comprises:
a) a plurality of sleeves for rotatably holding the axle shaft;
b) a terminating end cap fixed around the sleeve at the terminating end of the axle shaft;
c) a connecting end cap fixed around the sleeve at the connecting end of the axle shaft;
d) a center tube fixed around and between the terminating and connecting end caps; and
e) a end cap cover fixed to the terminating end cap.
